(19) United States
(12) Patent Application Publication
(10) Pub. No.: US 2026/0369490 A1
(43) Pub. Date: Nov. 19, 2026

(54) KEY AND KEYBOAR

(71) Applicant: MULTIDIMENSION TECHNOLOGY CO., LTD., Suzhou (CN)

(72) Inventors: Haochen Li, Suzhou (CN); Songsheng Xue, Suzhou (CN); Jinfeng Liu, Suzhou (CN); Liming Zhou, Suzhou (CN); Yiqian Zhou, Suzhou (CN)

(73) Assignee: MULTIDIMENSION TECHNOLOGY CO., LTD., Suzhou (CN)

(21) Appl. No.: 19/730,799

(22) Filed: Jul. 3, 2026

Related U.S. Application Data
(63) Continuation of application No. PCT/CN2024/133623, filed on Nov. 21, 2024.

(30) Foreign Application Priority Data
Nov. 5, 2024 (CN) 202422694072.2

(51) Int. Cl. H01H 13/14; H01F 7/02; H01H 13/70

(52) U.S. Cl. CPC H01H 13/14; H01F 7/02; H01H 13/70

(57) ABSTRACT

Provided are key and keyboard. The key includes first static magnet, multiple second static magnets, and moving magnet. Magnetization direction of the moving magnet and the second static magnets is along up-down direction, the moving magnet is fixedly disposed below pressing portion of the key and moves together with the pressing portion. The second static magnets are disposed outside moving magnet to force-balance the moving magnet in horizontal direction. Magnetization direction of the first static magnet is opposite to magnetization direction of the moving magnet, and the first static magnet is disposed directly below moving magnet, to provide upward repulsive force to moving magnet when pressing the key, eliminating tactile bump caused by abrupt inflection point of repulsive force from the second static magnets acting on the moving magnet. The key has reasonable layout, simple structure, no obvious tactile bump during pressing, good pressing feel, and excellent interactive experience.

### CROSS-REFERENCE TO THE RELATED APPLICATIONS

This application is a continuation application of International Application No. PCT/CN2024/133623, filed on Nov. 21, 2024, which is based upon and claims priority to Chinese Patent Application No. 202422694072.2, filed on Nov. 5, 2024, the entire contents of which are incorporated herein by reference.

### TECHNICAL FIELD

The present disclosure relates to the field of input and output devices for human-computer interaction, in particular to a key capable of eliminating tactile bump during pressing, and a corresponding keyboard.

### BACKGROUND

Physical keys are a very important type of input and output device, and widely used in electrical equipment such as mobile phones and computers. Among them, there is a type of physical key called a magnetic axis key, which uses a magnetic sensor to output a pressing signal by sensing movement of a magnetic axis. The magnetic axis key has advantages of rapid trigger while avoiding physical wear and having relatively good durability. This is mainly due to its short stroke length and low delay. For example, a common mechanical axis key requires a stroke of about 10 mm or more to complete two triggers; in contrast, the magnetic axis key requires only a few millimeters of stroke, and the response delay is only 1 ms.

However, existing magnetic axis keys typically use two magnets, i.e., a moving magnet and a static magnet, to generate relative motion when the key is pressed, causing a change in the magnetic field at a sensing point, and a corresponding magnetic sensor senses the change in the magnetic field to detect the pressing state of the key. Currently, magnetic axis keys usually dispose the static magnet below or on a side of the moving magnet. When the key is pressed, the relative distance between the moving magnet and the static magnet changes. However, since magnetic force is proportional to the square of the distance between magnets, when the static magnet is disposed below the moving magnet, the resistance of the key increases rapidly during the pressing process, even producing a blocking sensation that makes further pressing difficult; when the static magnet is disposed on a side of the moving magnet, an obvious tactile bump occurs when the moving magnet passes through staggered magnetic poles of the static magnet during the pressing process, seriously affecting the pressing feel.

### SUMMARY

To improve the pressing feel of existing magnetic axis keys and meet personalized pressing requirements of some users, the present disclosure proposes a key with a simple structure that effectively eliminates tactile bump during pressing and is easy to press, and a corresponding keyboard.

An embodiment of the present disclosure provides a key, which structurally includes: a first static magnet, a plurality of second static magnets, and a moving magnet.

The moving magnet is fixedly disposed below a pressing portion of the key and moves together with the pressing portion when the key is pressed, and a magnetization direction thereof is along an up-down direction. The first static magnet is disposed directly below the moving magnet, and a magnetization direction thereof is opposite to a magnetization direction of the moving magnet.

The plurality of second static magnets are identical, and a magnetization direction thereof is identical to a magnetization direction of the moving magnet. In a horizontal direction perpendicular to a pressing direction, the plurality of second static magnets are disposed outside the moving magnet such that the moving magnet is force-balanced in the horizontal direction; and in the pressing direction, bottoms of the plurality of second static magnets are not lower than a top of the first static magnet.

To detect a pressed state of the key, the key further includes a magnetic field sensor disposed below the first static magnet. The magnetic field sensor can be implemented based on a Hall sensing element or XMR magnetoresistance (including TMR, AMR, or GMR), further details of which are omitted herein.

When a lower end of the moving magnet crosses an N-S interface of the second static magnets, a repulsive force between the moving magnet and the second static magnets decreases quadratically; at the same time, a magnetic repulsive force between the first static magnet and the moving magnet increases quadratically, effectively eliminating a pressing tactile bump caused by an abrupt inflection point of the repulsive force from the plurality of second static magnets acting on the moving magnet.

Optionally, when the key is not pressed, the moving magnet is suspended between the plurality of second static magnets, and a bottom of the moving magnet is higher than an N-S pole interface of the second static magnets.

Optionally, the moving magnet is a cylindrical or bar magnet, and the second static magnets are cylindrical or bar magnets. The first static magnet is a cylindrical magnetic disc or a square magnetic disc.

In an embodiment, the first static magnet and the second static magnets are made of a low-magnetic material, and the moving magnet is made of a high-magnetic material. The key includes two second static magnets. The second static magnets and the moving magnet have the same shape and size. The second static magnet is a diametrically magnetized cylindrical magnet having a diameter of 3 mm and a height of 5 mm, and the first static magnet is a diametrically magnetized circular magnetic disc having a diameter of 3 mm and a height of 1 mm.

An embodiment of the present disclosure further provides a keyboard. The keyboard includes a plurality of keys, wherein at least one of the keys is the magnetic axis key described above.

Compared with the prior art, beneficial effects of the embodiment of the present disclosure include, for example:
compared with existing magnetic axis keys, the key provided in the present disclosure, based on a combined arrangement of static magnets and a moving magnet, with a simple physical structure, eliminates tactile bump during the pressing process and improves the pressing feel of the key.

### BRIEF DESCRIPTION OF THE DRAWINGS

FIG. 1 is a schematic diagram of a key provided by an embodiment of the present disclosure;

FIG. 2 is a schematic diagram showing shapes and sizes of various magnets in the embodiment shown in FIG. 1;

FIG. 3 is a simulation diagram showing a relationship between pressing displacement and magnetic resistance during a pressing process (without considering gravity of other components) of the key in the embodiment shown in FIG. 1; and

FIG. 4 is an exploded view of a key provided by an embodiment of the present disclosure.

### REFERENCE NUMERALS

10, moving magnet; 11, first static magnet; 12, second static magnet; 20, key base; 21, key upper cover; 22, key shaft cap; 221, bump.

### DETAILED DESCRIPTION OF THE EMBODIMENTS

The technical solutions in the embodiments of the present disclosure will be described clearly and completely below with reference to the accompanying drawings in the embodiments of the present disclosure. It is to be understood that the described embodiments are merely some, not all, embodiments of the present disclosure. The components of the embodiments of the present disclosure generally described and illustrated in the drawings herein may be arranged and designed in various different configurations.

Therefore, the following detailed description of the embodiments of the present disclosure provided in the accompanying drawings is not intended to limit the scope of the claimed disclosure, but merely represents selected embodiments thereof. Based on the embodiments of the present disclosure, all other embodiments obtained by those skilled in the art without creative effort shall fall within the scope of protection of the present disclosure.

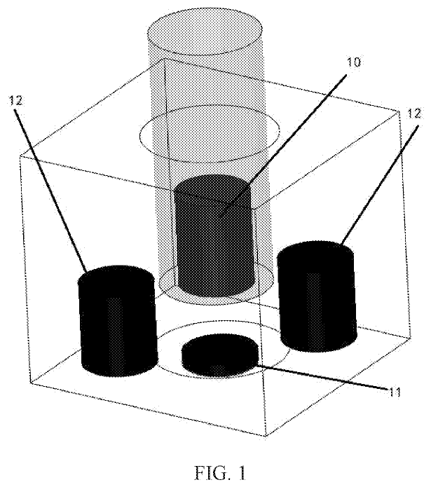

As shown in FIG. 1, in an embodiment, a key provided by the present disclosure includes a first static magnet 11, a plurality of second static magnets 12, and a moving magnet 10. The moving magnet 10 is fixedly disposed below a pressing portion of the key and moves together with the pressing portion when the key is pressed, and a magnetization direction thereof is along an up-down direction. The first static magnet 11 is disposed directly below the moving magnet 10, and a magnetization direction thereof is opposite to a magnetization direction of the moving magnet 10. The plurality of second static magnets 12 are identical, and a magnetization direction thereof is identical to a magnetization direction of the moving magnet 10.

In a horizontal direction perpendicular to a pressing direction, the plurality of second static magnets 12 are disposed outside the moving magnet 10 such that the moving magnet 10 is force-balanced in the horizontal direction.

In the pressing direction, bottoms of the plurality of second static magnets 12 are not lower than a top of the first static magnet 11. In the embodiment shown in FIG. 1, although the number of the second static magnets 12 is only two, this is merely illustrative and does not limit the number of the second static magnets 12 in the technical solution provided by the embodiment of the present disclosure. Actually, the number of the second static magnets 12 may also be three or more, as long as the moving magnet 10 is force-balanced in the horizontal direction through reasonable distribution.

For detection of key pressing, a magnetic field sensor (not shown in FIG. 1) disposed below the first static magnet 11 can be used. The magnetic field sensor can be implemented based on a Hall sensing element or XMR magnetoresistance (including TMR, AMR, or GMR), further details of which are omitted herein.

Further, the moving magnet 10 can be a cylindrical, bar, or square magnet, and the second static magnets 12 can be cylindrical, bar, or square magnets. The first static magnet 11 is a cylindrical magnetic disc or a square magnetic disc. The shapes and sizes of the moving magnet 10, the first static magnet 11, and the second static magnets 12 are not excessively limited herein. Actually, it is sufficient that magnetic forces from the plurality of second static magnets 12 and the first static magnet 11 on the moving magnet 10 enable the moving magnet 10 to be force-balanced in an initial state when the key is not pressed and to be suspended between the plurality of second static magnets 12.

Further, in the initial state when the key is not pressed, the moving magnet 10 is suspended between the plurality of second static magnets 12, and a bottom of the moving magnet 10 is higher than an N-S pole interface of the second static magnets 12.

In the embodiment shown in FIG. 1, the key includes two second static magnets 12. The second static magnets 12 and the moving magnet 10 are identical. The second static magnet is a diametrically magnetized cylindrical magnet having a diameter of 3 mm and a height of 5 mm, and the first static magnet is a diametrically magnetized circular magnetic disc having a diameter of 3 mm and a height of 1 mm.

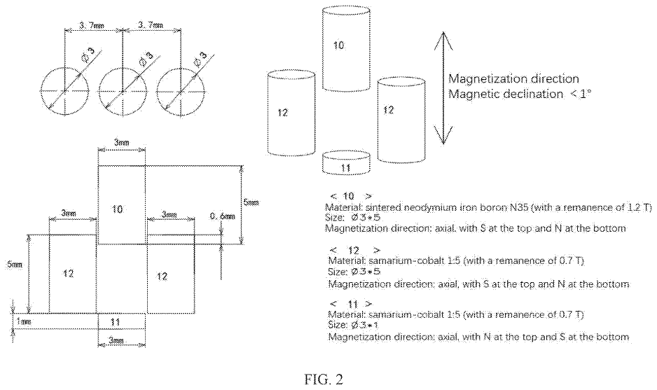

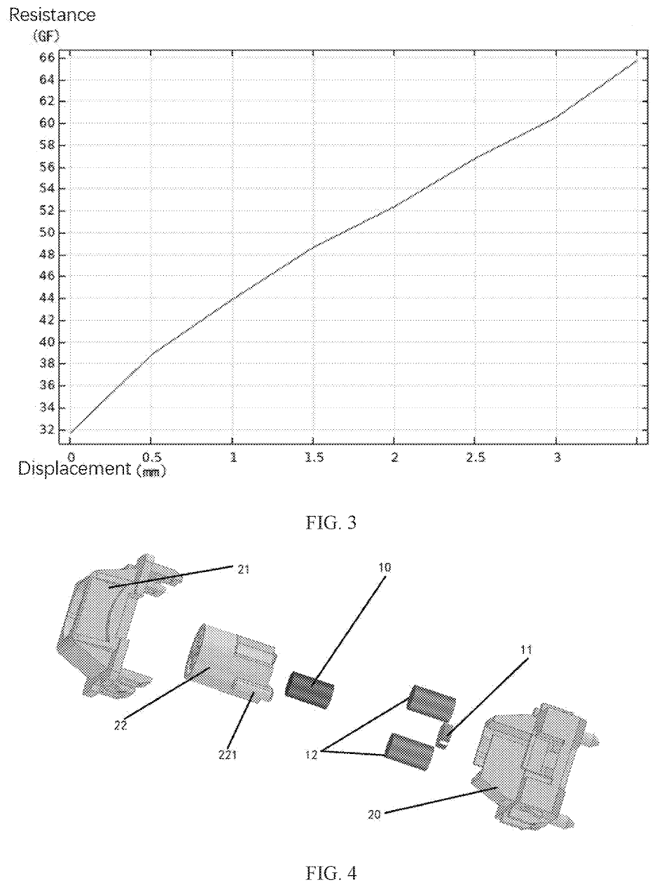

The positional relationship setting of individual magnets in FIG. 3 corresponds to the embodiment shown in FIG. 2. As shown in FIG. 3, an axial center distance between the moving magnet 10 and any second static magnet 12 is 3.7 mm, and a top of the first static magnet 11 and a bottom of the second static magnet 12 are on the same horizontal plane. In the initial state when the key is not pressed (without considering the mass of other components of the key), a bottom of the moving magnet 10 is about 0.6 mm lower than a top of the second static magnet 12. The first static magnet 11 and the second static magnets 12 are both made of a low-magnetic material (with a samarium-cobalt ratio of 1:5 and a remanence of 0.7 T), and the moving magnet is made of a high-magnetic material (sintered neodymium iron boron N35 with a remanence of 1.2 T). The key includes two second static magnets 12. The second static magnets 12 and the moving magnet 10 have the same shape and size.

FIG. 3 is a simulation diagram showing a relationship between pressing displacement and magnetic resistance during the pressing process (without considering gravity of other components) of the key in the embodiment shown in FIG. 1. In this simulation diagram, the horizontal axis represents pressing displacement (unit: mm) with the initial state as the coordinate zero point, and the vertical axis represents resistance (unit: GF) during pressing.

According to the dimensions of the second static magnet 12 and the moving magnet 10 shown in FIG. 2, in the absence of the first static magnet 11, when the pressing displacement is about 1.9 mm, the bottom of the moving magnet 10 crosses the N-S interface of the second static magnet 12, and the pressing resistance tends to decrease. However, the above situation does not exist in the simulation curve of FIG. 3 because when the lower end of the moving magnet 10 crosses the N-S interface of the second static magnet 12 and the repulsive force between the moving magnet 10 and the second static magnet 12 drops at an inflection point, the magnetic repulsive force between the first static magnet 11 and the moving magnet 10 increases, effectively compensating for the abrupt drop in the repulsive force from the plurality of second static magnets 12 acting on the moving magnet 10, thereby eliminating tactile bump during the key pressing process.

FIG. 4 is an exploded view of a key provided by an embodiment of the present disclosure. In the example shown in FIG. 4, in addition to a magnetic sensing assembly, a complete key includes a key base 20, a key upper cover 21, a key shaft cap 22, two second static magnets 12, a first static magnet 11, and a moving magnet 10. The key base 20 is provided with mounting positions for the second static magnets 12 and the first static magnet 11, and the moving magnet 10 is arranged in a magnet sleeve of the key shaft cap 22. A lower end of the moving magnet 10 mounted on the key shaft cap 22 passes through a shaft hole of the key upper cover 21, and an upper end surface thereof is exposed from the shaft hole. The key upper cover 21 and the key base 20 are combined via a snap fit to form an overall appearance of the key. A pressing stroke of the key can be limited by providing a bump 221 on a shaft of the key shaft cap 22.

Correspondingly, an embodiment of the present disclosure further provides a keyboard. The keyboard includes a plurality of keys, wherein at least one of the keys is the magnetic axis key described above. Preferably, when implemented as a keyboard, the second static magnet 12 is configured as a bar magnet.

The foregoing description merely illustrates embodiments of the present disclosure and is not intended to limit the present disclosure. For those skilled in the art, the present disclosure may have various modifications and variations. Any modifications, equivalent substitutions, improvements, etc., made within the spirit and principles of the present disclosure shall fall within the scope of protection of the present disclosure.

### Industrial Practicality

In summary, an embodiment of the present disclosure provides a key, including a first static magnet, a plurality of second static magnets, and a moving magnet. Through a combined arrangement of static magnets and a moving magnet, the first static magnet is disposed directly below the moving magnet, and a magnetization direction thereof is opposite to a magnetization direction of the moving magnet; the plurality of second static magnets are disposed outside the moving magnet such that the moving magnet is force-balanced in a horizontal direction, wherein the plurality of second static magnets are identical, and a magnetization direction thereof is identical to a magnetization direction of the moving magnet, thereby eliminating tactile bump during the pressing process with a simple physical structure and improving the pressing feel of the key.

1. A key, comprising: a first static magnet, a plurality of second static magnets, and a moving magnet, wherein
the moving magnet is fixedly disposed below a pressing portion of the key and moves together with the pressing portion when the key is pressed, and a magnetization direction of the moving magnet is along an up-down direction;
the first static magnet is disposed directly below the moving magnet, and a magnetization direction thereof is opposite to the magnetization direction of the moving magnet; and
the plurality of second static magnets are identical, and a magnetization direction thereof is identical to the magnetization direction of the moving magnet; in a horizontal direction perpendicular to a pressing direction, the plurality of second static magnets are disposed outside the moving magnet such that the moving magnet is force-balanced in the horizontal direction; and in the pressing direction, bottoms of the plurality of second static magnets are not lower than a top of the first static magnet.

2. The key according to claim 1, wherein when the key is not pressed, the moving magnet is suspended between the plurality of second static magnets, and a bottom of the moving magnet is higher than an N-S pole interface of the second static magnets.

3. The key according to claim 2, wherein the key further comprises a magnetic field sensor disposed below the first static magnet.

4. The key according to claim 1, wherein the first static magnet and the plurality of second static magnets are made of a low-magnetic material, and the moving magnet is made of a high-magnetic material.

5. The key according to claim 1, wherein the moving magnet is a cylindrical or bar magnet, and the plurality of second static magnets are cylindrical or bar magnets.

6. The key according to claim 5, wherein the first static magnet is a cylindrical magnetic disc or a square magnetic disc.

7. The key according to claim 6, wherein the key comprises two second static magnets, and the two second static magnets and the moving magnet have the same shape and size.

8. The key according to claim 7, wherein each of the two second static magnets is a diametrically magnetized cylindrical magnet having a diameter of 3 mm and a height of 5 mm, and the first static magnet is a diametrically magnetized circular magnetic disc having a diameter of 3 mm and a height of 1 mm.

9. A keyboard, comprising a plurality of keys, wherein at least one of the plurality of keys is the key according to claim 1.
